(19) United States
(12) Patent Application Publication
(10) Pub. No.: US 2003/0055685 A1
(43) Pub. Date: Mar. 20, 2003

(54) Systems and methods for monitoring administration of medical products

(75) Inventors: David M. Cobb, Bethlehem, PA (US); Christer O. Andreasson, Escondido, CA (US)

Correspondence Address: ORRICK, HERRINGTON & SUTCLIFFE, LLP, 4 PARK PLAZA, SUITE 1600, IRVINE, CA, 92614-2558, US

(73) Assignee: Safety Syringes, Inc.

(21) Appl. No.: 09/957,108

(22) Filed: Sep. 19, 2001

(51) Int. Cl. G06F 17/60

(52) U.S. Cl. 705/3

(57) ABSTRACT

Systems and methods are provided for monitoring administration of a medical product within a delivery device using a medicine data storage device attached to the delivery device that includes a product identifier identifying the medical product and an intended patient identifier identifying a patient intended to receive the medical product. Before administering the medical product to an individual patient, the product identifier and the intended patient identifier are uploaded into a reader, and a patient identifier is accessed from the reader's memory or uploaded from a patient identification device associated with the individual patient into the reader. The patient identifier is compared with the intended patient identifier to determine whether the individual patient is intended to receive the medical product. Once it is confirmed that the individual patient is intended to receive the medical product, the medical product is administered to the individual patient.

### FIELD OF THE INVENTION

The present invention relates generally to systems and methods for administering or dispensing medical products, and more particularly to systems and methods for administering, dispensing, monitoring, and/or tracking the delivery of pharmaceuticals or other medical products to individuals in order to minimize or avoid adverse events.

### BACKGROUND OF THE INVENTION

Monitoring and/or tracking delivery of pharmaceuticals, drugs, or other medical products is a difficult task. Present practice generally relies upon a healthcare provider, e.g., nurse or doctor, to confirm manually whether a drug should be administered to a particular patient. The provider may consult a patient's chart before administering a drug to the patient in order to confirm the patient's identity and/or to verify that the drug is prescribed to the patient. Alternatively, a dispensing device from which a product is removed may automatically confirm that a requested drug is intended for an identified patient. A provider, however, may remove multiple medical products intended for different patients from a dispensing device at one time, which may introduce a risk of administering the wrong product to the wrong patient. In addition, it may be difficult to track drug interactions, i.e., that a medical product being administered to a patient may react adversely with another product being given to the patient.

U.S. Pat. No. 5,845,264, issued to Nellhaus, discloses applying a barcode to individual drugs, e.g., pills and capsules, in order to track the drugs, to identify individuals receiving the medications, or to monitor for possible drug interactions. A reader is disclosed that may be used to scan the barcode, the reader having a display for providing an image of the drug associated with the bar code. The system involves manual entry of patient information to obtain a picture corresponding to the patient to verify a patient's identity. This system, however, introduces many levels of human error, e.g., in entering patient information and/or in determining whether images displayed on the reader match a product and/or an intended patient.

Accordingly, systems and methods for reviewing, monitoring, or tracking administration of pharmaceuticals, immunizations, or other medical products, e.g., to reduce medical error, would be considered useful.

### SUMMARY OF THE INVENTION

The present invention is directed to systems and methods for monitoring administration of medical products, and more particularly to systems and methods for reviewing, monitoring, or tracking the delivery of pharmaceuticals, immunizations, or other medical products to individuals using electronic devices.

In accordance with one aspect of the present invention, a system is provided for monitoring administration of a medical product to a patient that includes a delivery device, a patient identification device, and an electronic reader. The delivery device includes a medical product therein and a medicine data storage device attached to the delivery device. The medicine data storage device may include a product identifier identifying the medical product and/or an intended patient identifier identifying a patient intended to receive the medical product. The patient identification device may include a patient data storage device including a patient identifier, the patient data storage device being associated with an individual patient, whereby the patient identifier may uniquely identify the individual patient.

The electronic reader is configured for uploading the product identifier and the intended patient identifier from the medicine data storage device, and/or for uploading the patient identifier from the patient data storage device associated with an individual patient. A processor is coupled to the reader, e.g., within the reader itself or coupled to the reader via a network. The processor is configured for comparing the patient identifier with the intended patient identifier to determine whether the patient identifier and the intended patient identifier match. An output device, e.g., a display on the reader, a speaker, and/or a printer, may be provided for indicating whether the patient identifier and the intended patient identifier match, thereby confirming whether the individual patient is intended to receive the medical product.

In accordance with another aspect of the present invention, a system is provided for administering a medical product to a patient that includes a delivery device and an electronic reader. The delivery device may include a medical product therein and a medicine data storage device attached to the delivery device. The medicine data storage device may include a product identifier identifying the medical product and an intended patient identifier identifying a patient intended to receive the medical product. The reader may be configured for uploading the product identifier and the intended patient identifier from the medicine data storage device.

Memory may be coupled to the reader for storing a patient identifier, the patient identifier uniquely identifying the individual patient. A processor may be coupled to the reader for comparing the patient identifier with the intended patient identifier to determine whether the patient identifier and the intended patient identifier match. An output device may be provided for indicating whether the patient identifier and the intended patient identifier match, thereby confirming whether the individual patient is intended to receive the medical product. The memory, processor, and/or output device may be part of the reader and/or may be coupled to the reader via a computer network, e.g., a local area network.

In accordance with another aspect of the present invention, a method for administering a medical product to a patient is provided. Initially, a delivery device may be provided with a medicine data storage device attached thereto. A medical product may be loaded into the delivery device, and a product identifier may be downloaded onto the medicine data storage device, the product identifier identifying the medical product loaded into the delivery device.

Before administering the medical product, the product identifier may be uploaded from the medicine data storage device into a reader. A patient record associated with an individual patient may be accessed to confirm whether the individual patient is intended to receive the medical product identified by the product identifier. Once it is confirmed that the individual patient is intended to receive the medical product, the medical product may be administered to the individual patient.

Preferably, the patient record is a patient data storage device storing a patient identifier associated with the individual patient. For example, the patient data storage device may be a barcode, a magnetic strip, or an electronic recording device, e.g., a “smart” chip, attached to a wristband or other device secured to the individual patient. An intended patient identifier may be downloaded onto the medicine data storage device when the delivery device is filled. Before administering the medical product, the patient identifier may be uploaded from the patient data storage device into the reader, and the patient identifier may be compared with an intended patient identifier uploaded from the medicine data storage device to confirm that the individual patient is intended to receive the medical product.

Alternatively, the patient record and/or the patient identifier may be stored in memory of the reader, which may be assigned or otherwise uniquely associated with the individual patient identified by the patient identifier. In a further alternative, the patient record may be stored in another device coupled to the reader via a local network. The patient identifier may be retrieved and compared to the intended patient identifier uploaded by the reader to confirm whether the individual patient is intended to receive the medical product.

In addition, other verification procedures may be performed before delivering the medical product. For example, drug interaction data may be accessed from a product database related to the medical product identified by the product identifier. A patient history file of the individual patient may be accessed to confirm whether the medical product is interaction-free from other medical products already received by the individual patient. Preferably, these verifications are performed automatically by the reader and/or by another computing device coupled to the reader, e.g., within a local network or via a communications network.

In accordance with yet another aspect of the present invention, a method is provided for monitoring administration of a medical product to a patient. A delivery device is provided that includes a medical product therein and a medicine data storage device attached to the delivery device. The medicine data storage device includes a product identifier identifying the medical product and an intended patient identifier identifying a patient intended to receive the medical product.

Before administering the medical product to an individual patient, the product identifier and the intended patient identifier are uploaded from the medicine data storage device into a reader, and a patient identifier is uploaded from a patient identification device associated with the individual patient into the reader. The patient identifier is compared with the intended patient identifier to determine whether the individual patient is intended to receive the medical product. Once it is confirmed that the individual patient is intended to receive the medical product, the medical product is administered to the individual patient.

In accordance with still another aspect of the present invention, a system is provided for acquiring data related to a medical product being administered to a patient that includes a container, a patient identification device, and a local network including an electronic reader and memory. The container includes a medical product therein, the medical product being deliverable from the container to a patient, either directly or by transferring the medical product into individual dose delivery devices. The medicine data storage device is attached to the container, the medicine data storage device including a product identifier stored therein. The patient identification device is associable with an individual patient, the patient identification device including a patient data storage device storing a patient identifier identifying the individual patient.

The reader is configured for acquiring the product identifier from the medicine data storage device and the patient identifier from the patient data storage device. A communications interface may be coupled to the reader for acquiring product data associated with the product identifier. The memory may be provided in a server or other provider computer within the local network for storing the product and patient data in a patient tracking file.

In addition, the system may include a host computer at a location remote from the local network, the host computer communicating with the local network via a communications network. The host computer may include a medical product database, the host computer configured for including at least a portion of the tracking file in the medical product database. For example, the server or other provider computer may periodically communicate at least a portion of patient data and product data in tracking files in the memory of the provider computer to the host computer. Preferably, the provider computer is configured for communicating at least a portion of patient data, e.g., demographic data of patients receiving respective medical products, to the host computer while excluding personal information capable of identifying respective patients.

In accordance with yet another aspect of the present invention, a method is provided for acquiring data related to a medical product being administered to a patient. A container is provided at a provider location, the container including a medical product therein and a medicine data storage device storing a product identifier, similar to the embodiments described above. The product identifier may be uploaded into a local network at the provider location, e.g., using a reader. Product data may be acquired from a product database stored on a host computer at a remote location from the local network, the product data being identified by the product identifier. The medical product may be administered to an individual patient, and administration date data may be entered into a patient data file generally at the time of administering the medical product to the individual patient. The patient data file is preferably stored on the local network, the patient data file including a patient identifier identifying the individual patient, the product data may be added to the patient data file.

Preferably, the product data and patient data, preferably, demographic data, in the patient data file are communicated to a location remote from the provider computer. More preferably, personal information included in the patient data file that is capable of identifying the individual patient is excluded from any data communicated to the remote location. The product data and demographic data may be communicated to a host computer for inclusion in a medical product database.

Other objects and features of the present invention will become apparent from consideration of the following description taken in conjunction with the accompanying drawings.

### BRIEF DESCRIPTION OF THE DRAWINGS

These and other features, aspects and advantages of the present invention will become better understood with regard to the following description, appended claims and accompanying drawings where:

FIG. 1 shows a first preferred embodiment of a system for monitoring administration of a medical product to a patient, in accordance with the present invention.

FIG. 2 is a schematic of a reader for use with the system of FIG. 1.

FIG. 3 is a side view of a delivery device including a medicine data storage device attached thereto, in accordance with the present invention.

FIG. 4 is a perspective view of a medical container including a medicine data storage device attached thereto that is used to provide medical product to a plurality of individual delivery devices also including respective medicine data storage devices, in accordance with the present invention.

FIG. 5 is a flowchart, showing a method for monitoring administration of a medical product to a patient, in accordance with the present invention.

FIG. 6 shows a system for tracking data related to administration of medical products to patients, in accordance with the present invention.

### DESCRIPTION OF THE PREFERRED EMBODIMENTS

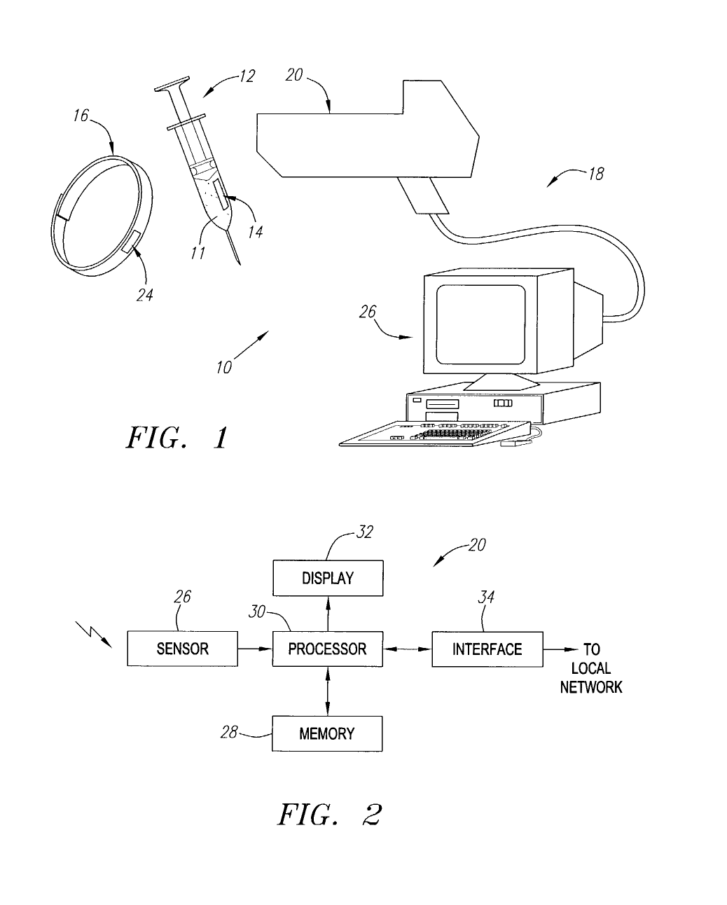

Turning to the drawings, FIG. 1 shows a first preferred embodiment of a system 10 for monitoring administration of a medical product 11 to a patient (not shown), in accordance with the present invention. Generally, the system 10 includes a delivery device 12 having a medicine data storage device 14 attached thereto, a patient identification device 16, and a local network 18. The local network 18 may include an electronic reader 20 for acquiring data from the medicine data storage device 14 and/or a local computer 22.

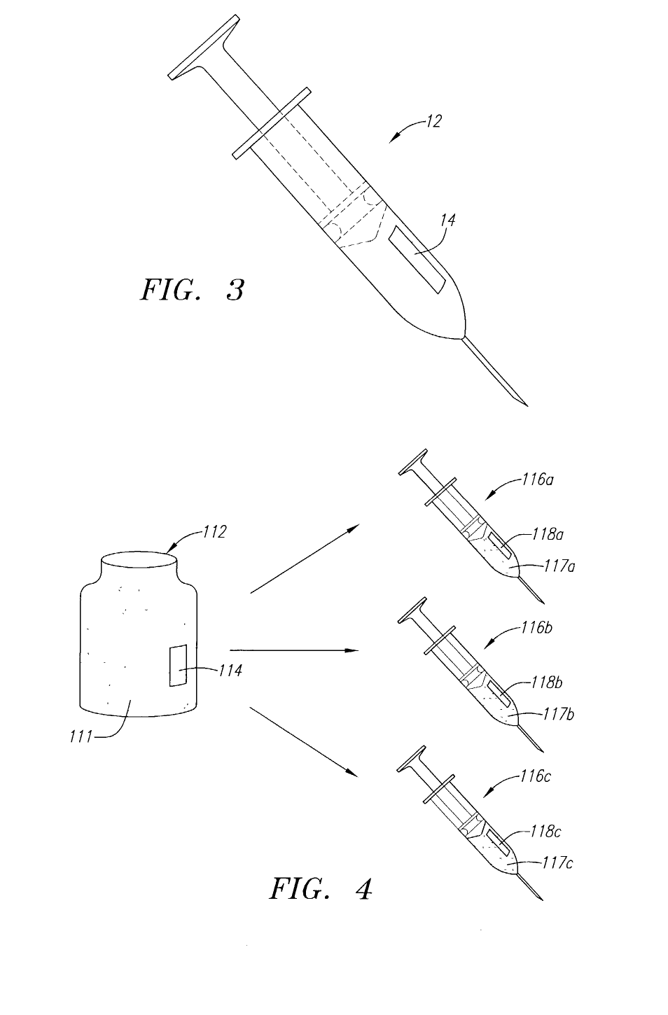

Generally, the delivery device 12 is any device that may be used to provide a medical product to an individual patient. In a preferred embodiment, the delivery device 12 is a syringe or other injection device, such as that shown in FIG. 3, that contains a medical product, such as a vaccine, pharmaceutical, or other therapeutic or diagnostic agent. More preferably, the delivery device 12 is a unit-dose device, such as a pre-filled syringe or ampoule. In addition, or alternatively, the delivery device 12 may include a holder (not shown) within which a syringe or other medical cartridge may be received and/or a needle guard device (not shown) that may be attached to a syringe or medical cartridge. Exemplary needle guard devices that may be used are disclosed in U.S. Pat. Nos. 5,624,400 and 6,171,283, the disclosures of which are expressly incorporated herein by reference. In further alternatives, the delivery device 12 may be a medical container, such as a vial or bottle, as shown in FIG. 4, e.g., for a liquid medical product, a box, e.g., for a solid medical product, an inhaler, an aerosol or spray canister, a skin patch, or packaging (not shown) from which a medical product may be removed and administered to a patient. In yet a further alternative, the delivery device 12 may include multiple medical products therein, such as an IV bag (not shown), that may be administered to a patient together.

The medicine data storage device 14 is attached to the delivery device 12, preferably such that the medicine data storage device 14 is substantially inseparable from the delivery device 12 before administration to a patient. Preferably, the medicine data storage device 14 is a read/write machine-readable communications device, such as an electronic recording device, e.g., a “smart” chip or “smart” label, a magnetic strip, and the like. The electronic recording device may include a processor, memory, and/or an interface, such as an antenna or connector, for communicating with the reader 20 or other external device. Alternatively, the medicine data storage device 14 may be a read-only device, such as a barcode strip. The medicine data storage device 14 is preferably attached to the delivery device 12 such that it does not interfere substantially with use of the delivery device 12 but may be accessed by other devices, such as the reader 20. For example, the medicine data storage device 14 may be attached to a syringe barrel, as shown in FIG. 1, or secured to or within a wall of a syringe holder, to a plunger, or to a syringe safety device, such as a needle guard (not shown).

The medicine data storage device 14 is capable of storing information related to the medical product 11 within the delivery device 12. For example, the medicine data storage device 14 may include a product identifier uniquely associated with the medical product 11. The product identifier may identify the product type, its manufacturer, lot number, and/or expiration date. For example, a serial number system may be used that provides an exemplary serial number A31CJ1Z5, wherein “A3” identifies a specific manufacturer, “1CJ” identifies a specific product, and “1Z5” identifies a specific lot. Alternatively, the product identifier may be uniquely associated with one or more entries in a database that may be accessed to obtain information related to the medical product 11.

In addition, the medicine data storage device 14 may be capable of storing other information, such as dosage data, e.g., identifying an amount and/or concentration of the medical product 11 within the delivery device 12 or identifying a required frequency of administration, and/or an intended patient identifier identifying a patient intended to receive the medical product 11, as explained further below. Other optional information that may be stored includes product manufacturing date, administration requirements, instructions for use, and/or product warnings, such as possible allergic reactions or adverse interactions of the product with other medical products.

Returning to FIG. 1, the patient identification device 16 is associated with an individual patient (not shown), and includes a patient data storage device 24 storing a patient identifier. For example, the patient identifier may be a patient's name, social security number, or other unique identifier, e.g., associated with a patient upon admittance to a medical provider facility. Optionally, the patient data storage device 24 may include other information related to the patient, e.g., medical products being received, allergy information, and the like.

The patient data storage device 24 is preferably associated with an individual patient in such a way that the patient identifier uniquely identifies the individual patient. In a preferred embodiment, the patient identification device 16 is a wristband or other device that may be secured to a patient. Exemplary embodiments of wristband devices that may be used as patient identification devices are disclosed in U.S. Pat. No. 5,973,600 issued to Mosher, Jr., the disclosures of which are expressly incorporated herein by reference.

Alternatively, the patient identification device 16 may be provided on a patient chart or other object kept in close proximity to the patient, e.g., on or adjacent to the patient's bed, wheelchair, and the like. In a further alternative, the patient identification device 16 may be eliminated, and the reader 20 may include memory for storing the patient identifier and/or patient data, as explained further below.

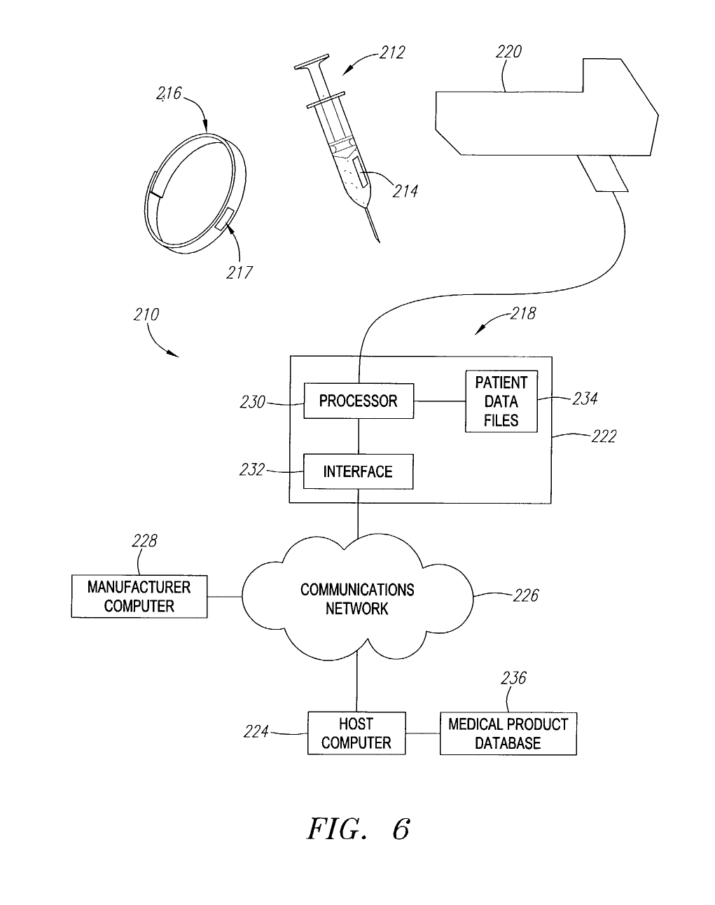

Turning to FIG. 2, the reader 20 is an electronic device configured for uploading information from a storage device into the reader 20, and/or for transferring uploaded information elsewhere into the local network 18 (not shown, see FIG. 1 or 6), or to a location remote from the provider facility, such as a host computer (also not shown, see, e.g., FIG. 6). Generally, the reader 20 may include a sensor 26, memory 28, a processor 30, and a display 32. Optionally, the reader 20 may also include one or more other user interfaces, such as a keypad, a mouse, and the like (not shown). In addition, the reader 20 optionally may be coupled to other components of the local network 18, e.g., to the local computer 22 shown in FIG. 1, e.g., by an interface 34. The interface 34 may be a cable directly coupling the reader 20 to the local network 18 or may be a wireless communications device, such as a short-range transmitter/receiver, a modem, and the like. Alternatively, the reader 20 may be a stand-alone device, e.g., with an internal processor and memory capable of performing any or all of the tasks described below. In a further alternative, the reader 20 may include a base unit, e.g., including a processor and memory and a portable sensor coupled to the base unit, e.g., by a cable or wireless interface (not shown).

The reader 20 is generally configured for uploading information from the medicine data storage device 14 and/or the patient identification device 16. For example, the delivery device 12 and the reader 20 may be placed in close proximity to one another in order to upload the product identifier and/or other information stored in the medicine data storage device 14 (shown in FIG. 1). For example, the sensor 26 may be placed against or in close proximity to the medicine data storage device 14, and the product identifier or other information may be uploaded and stored in the memory 28 and/or passed to the local network via interface 34. In addition, the sensor 26 may also be configured for uploading the patient identifier or other information from the patient identification device 16 (shown in FIG. 1) associated with an individual patient (not shown). Alternatively, the reader 20 may include the patient identifier in internal memory. Optionally, the reader 20 may also be capable of writing to the medicine data storage device 14 and/or patient identification device 16, as described further below.

The processor 30 of the reader 20 may be configured for performing several tasks. For example, with further reference to FIG. 1, the processor 30 may compare a patient identifier acquired from a patient identification device 16 (or from the reader's memory) associated with a patient with an intended patient identifier acquired from a medicine data storage device 14 attached to a delivery device 12 to determine whether the patient is intended to receive the medical product 11 in the delivery device 12, as described further below. In addition or alternatively, the processor 30 may use a product identifier acquired from the medicine data storage device 14 to request or otherwise obtain additional information regarding the medical product 11 within the delivery device 12, e.g., from elsewhere in the local network 18 or from a host computer or other remote device (not shown). The processor 30 may use a patient identifier acquired from the patient identification device 14 to request or otherwise obtain information regarding the patient. Alternatively, the processor 30 may use the product and patient identifiers to access a database stored in the memory 28 to confirm whether the patient is the intended recipient of the medical product 11 and/or to confirm whether there are any drug interaction concerns. In a further alternative, the reader 30 may merely acquire the product and patient identifiers in order to send them to another device, e.g., within the local network 18 or at a remote location, in order to complete such confirmations.

Selective portions or all of the information acquired by the processor 30 may be displayed on the display 32, which may be any known output device, e.g., an LCD, LED's, a speaker, and/or a printer. The display 32 may also provide visual and/or audio indications when the processor 30 has performed one or more comparisons or confirmations, such as those tasks described above.

Before the reader 20 of FIG. 2 is used to acquire data, and/or the system 10 of FIG. 1 is used to monitor administering a medical product to a patient, the medicine data storage device 14 may need to be prepared, i.e., loaded with data. In one embodiment, a manufacturer or filler of a medical product 11 may download or otherwise provide information to one or more medicine data storage devices 14. For example, upon filling individual delivery devices 12 or other containers with a medical product, an electronic reader/writer (not shown) may be used initially to download a product identifier and/or product data to the medicine data storage devices 14 attached to respective delivery devices 12. If necessary or desired, the data may be read and/or supplemented during one or more steps of manufacturing, filling, or assembly. Preferably, the medicine data storage devices 14 are electronic recording devices, e.g., “smart” chips, that may be programmed, although alternatively, barcode stickers or magnetic strips may be used instead. For barcode stickers, a bar code sticker printer may be used to generate initial bar code stickers, and/or to read existing bar code stickers and print new ones with new or supplemented data. The manufacturer may maintain a file in its computer system of all or part of the data downloaded to respective medicine data storage devices 14 and/or may transfer the data to a host computer (not shown), as described further below. The delivery devices 12, including respective medicine data storage devices 14 with data stored thereon, may be shipped to one or more provider locations for administration to respective patients.

In a preferred embodiment, this method may be used to identify contents of a single-use or unit-dose delivery device or container. Alternatively, this method may be used to identify a medical product 111 in a bulk container 112 that may be transferred into individual delivery devices 116, as shown in FIG. 4. The bulk container 112 may include a medicine data storage device 114, including a product identifier and/or product data, similar to the delivery device 14 described above. Optionally, the medicine data storage device 114 may also include quantity data identifying how much of the medical product 111 is provided in the bulk container 112. The bulk container 112 may be shipped to a pharmacy or other provider location where the medical product 111 may be separated into individual doses. For example, a pharmacist or other individual may have a reader/writer (either a single device or two separate devices, not shown) that may be used to acquire the product identifier and/or product data from the medicine data storage device 114.

The medical product 111 may be transferred into one or more individual containers or delivery devices, such as the three exemplary delivery devices 116 shown in FIG. 4. Each delivery device 116 includes a medicine data storage device 118 attached thereto, similar to the embodiment described above. The product identifier and/or product data may be downloaded to the medicine data storage devices 118 of the respective individual delivery devices 116. Optionally, additional information may be added to the medicine data storage devices 118, such as date of filling or preparing the delivery devices 116, dosage data identifying how much of the medical product 111 is transferred into the respective delivery devices 116, and the like. In addition, an intended patient identifier may be downloaded to the medicine data storage devices 118, e.g., to identify an intended recipient for the respective amount of medical product 117 in each of the delivery devices 116. Thus, an individual filling the individual delivery devices 116 may fill specific orders or prescriptions designated for particular individual patients.

In a preferred embodiment, as shown in FIG. 1, all of this uploading and downloading may be performed using a device, similar to reader 20, that is coupled to a local network 18 at the provider location, thereby allowing patient records to be simultaneously generated and/or maintained, e.g., on a local computer 22 coupled to the local network 18. These records may include any or all of the information regarding the medical products in delivery devices that are to be received and/or have already been received by respective individual patients. In addition, the product data, e.g., including dosage data, may be maintained in an inventory database maintained by the local computer 22 or other component in order to track amounts of medical products held in stock and/or being administered to patients.

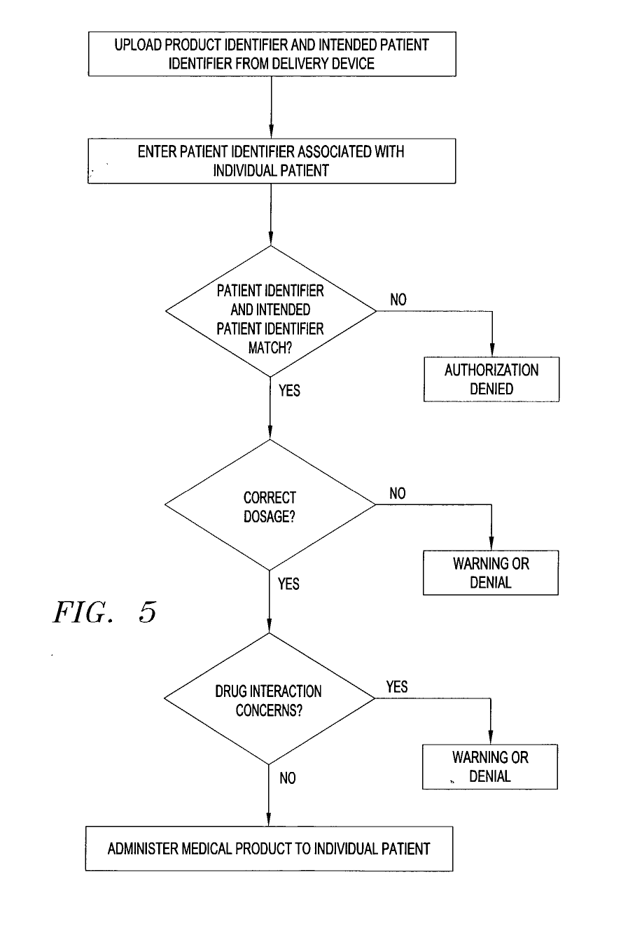

Turning to FIG. 5, a method for monitoring administration of a medical product to a patient is shown that may use a reader, a delivery device, and/or a patient identification device, such as those described above. First, a delivery device may be provided that includes a medical product therein and a medicine data storage device attached thereto. The medicine data storage device may include a product identifier identifying the medical product, an intended patient identifier identifying a patient intended to receive the medical product, and/or dosage data indicating an amount of the medical product in the delivery device. The product identifier, intended patient identifier, and/or dosage data may be previously stored on the medicine data storage device, e.g., using one of the methods described above.

In addition, a patient identification device may be provided that is associated with each individual patient. A patient data storage device may be attached to a patient identification device, e.g., a wristband or other device, that may be secured to an individual patient. Preferably, a patient identifier and/or patient data related to the individual patient are downloaded to the patient data storage device, e.g., during admittance of the individual patient to the provider location. Alternatively, a preloaded identifier on a patient data storage device may be associated with an individual patient, e.g., during admittance. The patient identification device may be secured to the individual patient such that the patient identification device, and consequently the patient data storage device, remain with the individual patient while at the provider location, thereby ensuring that the patient identifier and/or patient data remain associated with the correct individual patient.

Optionally, an individual provider identification device (not shown) may also be provided that includes an electronic storage device, similar to those described above, for storing an individual provider identifier that uniquely identifies an individual healthcare provider. For example, each doctor or nurse may carry a identification badge, wristband, and the like (not shown) that includes a storage device, such as a smart chip, a magnetic strip, or a barcode that may be read by a reader, such as the reader shown in FIG. 2. Before the reader may be used to perform any of the tasks identified below, the individual provider may be required to upload his/her individual provider identifier into the reader, e.g., by passing the identification device through or in close proximity to the reader. Alternatively, the individual provider may manually enter his/her individual provider identifier into the reader. This optional step may be used to initialize the reader, to identify a responsible individual, and/or may confirm that the individual provider is authorized to administer medical products to particular individuals. In a further alternative, a reader may be associated with each individual healthcare provider, the reader storing the individual provider identifier in internal memory. Thus, any activities performed by the reader may be ascribed to the individual provider associated with the particular reader.

At step 312, the product identifier and/or the intended patient identifier from the medicine data storage device may be uploaded into the reader, as described above. At step 314, a patient identifier and/or other patient data may be uploaded from a patient data storage device associated with an individual patient, preferably into the same reader. The order of these uploading steps is not important to the method and may be performed in any order. Alternatively, if a patient identification device is not used, a patient identifier identifying the individual patient may be entered into the reader, e.g., manually, and/or by selection from a menu of patients displayed on the reader. In a further alternative, the patient identifier may be preloaded in memory of the reader, e.g., by assigning the reader to the individual patient.

At step 316, the patient identifier may be compared with the intended patient identifier to determine whether the individual patient associated with the patient identifier is intended to receive the medical product within the delivery device. This comparison may be performed entirely by the reader, e.g., if the reader is portable enough to be brought into close proximity with the individual patient and/or if the reader has sufficient processor and memory capabilities. Alternatively, the reader may act merely as an input/output device coupled to a local network. In this alternative, the reader may be used to upload the patient and product identifiers for transmission to another device included in the local network, e.g., a central confirmation computer. Upon receiving the patient and product identifiers, the central confirmation computer may perform the comparison. The result of the comparison may then be relayed back to the reader.

As indicated at step 318, if the patient identifier and intended patient identifier do not match, the reader may display “authorization denied” or other negative output, indicating that administration of the medical product to the individual patient should not proceed. If the patient identifier and the intended patient identifier do match, one or more additional verification steps may be performed, if desired, or administration of the medical product may proceed at step 328.

For example, at step 320, dosage data acquired from the medicine data storage device may be compared to desired dosage data associated with the individual patient, e.g., included in the patient identification device. The desired dosage data may include dosage amount requirements and/or frequency of administration requirements. The reader (or other device coupled to the reader) may confirm whether the dosage of the medical product matches the individual patient's requirements. Thus, the reader may confirm whether the individual patient is receiving a correct dosage and/or whether the individual patient is receiving a duplicative treatment. For example, the reader may include or may access a database including patient records that store when individual patients have received medical products, how much they have received, and the like.

If the dosage data and the desired dosage data do not match appropriately, at step 324, a denial or a warning may be output, e.g., instructing the provider to verify or adjust the dosage in a particular manner or to delay administration until a later time. Alternatively, at step 326, if the data match, a confirmation may be output, whereupon any additional verifications may be performed. For example, the reader may include or may access a drug interaction database, allowing the reader or other network component to confirm whether the medical product is unlikely to have any adverse interactions with other medical products being given to the individual patient.

Any or all of these verification steps may be performed by a portable reader that may be taken into close proximity with the individual patient, e.g., into the individual patient's room. If the reader has sufficient processor and/or memory capacity, any comparison and/or data storage may occur entirely within the reader. Alternatively, the reader may merely act as an interface, with some or all of the verification steps being performed elsewhere within the local network and/or at a remote location. In a further alternative, one or more of the verification steps may be performed before the medical product is taken to the individual patient, e.g., at a nurse's station or dispensing device, which may require manual entry of the patient identifier associated with the individual patient. In further alternatives, the medicine data storage device may be attached to a patient chart and/or to an object in close proximity to the individual patient, and appropriate precautions may be taken to confirm that the medicine data storage device remains associated with the correct individual patient.

In yet another alternative, a reader may be positioned in close proximity to the individual patient, e.g., mounted bedside or within the patient's room, that is preloaded with the patient identifier and/or other patient data. The reader may upload the product identifier or other data from the delivery device to confirm whether the medical product in the delivery device is intended for the individual patient associated with the particular reader.

If the reader confirms that the individual patient is intended to receive the medical product and/or the other verification steps have a positive outcome, the reader may produce an output indicating to proceed with administering the medical product. Then, at step 328, the medical product may be administered to the individual patient in a conventional manner, e.g., by injection and the like. Thus, systems and methods in accordance with the present invention may provide enhanced assurance that the correct patient is receiving the correct medical product, thereby minimizing the risk of medication error. Optionally, the reader may be capable of writing to the patient identification device, e.g., to create a record that the medical product was actually administered to the individual patient. Alternatively, the reader may store the record in its memory or transfer it to another component of the local network, e.g., to create or update a patient data file, as described further below.

Turning to FIG. 6, a system 210 for tracking administration of medical products to one or more patients is shown that may be used in conjunction with or separate from the monitoring system described above. Generally, the system 210 includes a local network 218 located at a provider location. The local network 218 may include one or more readers 220 (only one shown for simplicity) and one or more local computers 222, which may be similar to the local network 18 described above. In addition, the system 210 may include one or more host computers 224 located remotely from the local network 218. The local network 218 and the host computer 224 may have access and/or be connected to a communications network 226, such as the Internet. In addition, the system 210 may include one or more manufacturer computers 228, which may have access to and/or be connected to the network 226. Preferably, the local network 218 and the manufacturer computer 228 may communicate with the host computer 224 via the communications network 226, but not directly with one another. Although only one local network 218 and one manufacturer computer 228 are shown, it will be appreciated that any number of providers and manufacturers may have networks and/or computers that may communicate with the host computer 224 via the communications network 226.

The local computer 222 generally includes a processor 230, an interface 232 for communicating via the communications network 226, and memory 234 including patient data files, as described further below. The reader 220 may be coupled to the local computer 222 by any conventional device, e.g., directly by a cable, by a wireless transmitter/receiver, and/or by a local area network interface (not shown). The local computer 222 may include multiple discrete components or computer devices together or distributed about the local network 218 in addition to or instead of the processor 230, interface 232, and memory 234, which may perform the tasks described herein or that may be unrelated to the operation of the system 210, as will be appreciated by those skilled in the art. In addition, the local computer 222 may include patient data files 234 including patient identifiers identifying individual patients, and other information related to the individual patients. For example, the patient data files may include patients' names, addresses, personal information, e.g., race, sex, age, etc., medical history, allergies, scheduled medications or prescriptions, and the like.

A manufacturer may download product data into a medicine data storage device 214 attached to each of its delivery devices (a representative delivery device 212 being shown in FIG. 6) or other product containers or packaging (not shown). Because of limited capacity of the medicine data storage device 214, it may be desirable to minimize the information stored thereon, and, instead, provide only an identifier that may be used to acquire product data associated with the medical product therein. For example, a product identifier, e.g., a serial number similar to that described above, may be stored on the medicine data storage device 214. The manufacturer may store additional product data associated with the product identifier within its internal computer systems, as represented by manufacturer's computer 228.

Preferably, the manufacturer transfers the product data to the host computer 224, which may store the product data in a medical product database 236. The host computer 224 may be configured for accessing product data related to a specific medical product if provided with the corresponding product identifier, and/or may store additional data related to administration of the medical product received from providers, as described further below. The delivery devices, including the delivery device 212, may then be shipped to one or more provided locations for administration to individual patients.

Before administering the medical product in a delivery device 212 to an individual patient (not shown), the product identifier stored in the medicine data storage device 214 may be uploaded into the local network 218 at the provider location. For example, the reader 220 may be used to acquire the product identifier, as described above, and the product identifier may be transferred to the local computer 222 coupled to the local network 218. The local computer 222 may query the medical product database 236 stored on the host computer 224 via the communications network 226, submitting the product identifier and requesting product data associated with the product identifier from the host computer 224. The host computer 224 may then obtain any product data associated with the submitted product identifier, and transfer the product data to the local computer 222 via the communications network 226. Alternatively, the product data may be transferred to the local computer 222 when the delivery device 212 is received from the manufacturer. Thus, the local computer 222 may already include a local database including product data that may be accessed by providing an associated product identifier.

Using the product identifier, one or more confirmations may be completed at the provider location, which may be performed by the reader 220, the local computer 222, and/or other components of the local network 218, before administering the medical product. For example, the reader 220 may acquire a patient identifier associated with the individual patient, as described above, which may be used to identify a patient data file associated with the individual patient. The product data received from the host computer 224 may be used to identify the medical product in the delivery device 212, which may then be correlated with data in the individual patient's data file. For example, the local computer 222 may confirm that the individual patient is not allergic to the medical product identified by the product identifier. In addition, the local computer 222 may access any other medical products being received by the individual patient, and consult a drug interaction database to confirm that there are no adverse reactions with the medical product being administered. Further, the local computer 222 may consult a history in the patient data file to confirm that dosage of the medical product is correct or that administration is not being duplicated (i.e., that the medical product is being administered within a desired frequency). If any of these confirmations indicate that administration should not proceed, the reader 220 may provide an output to discontinue administration or to correct administration, e.g., to correct dosage, and the like.

If the results of any and all confirmations performed are positive, the medical product may then be administered to an individual patient, e.g., by injection and the like. Upon reading the medicine data storage device 214, and confirming that administration should proceed, data may be added to the patient data file. For example, administration time data identifying the time of administering the medical product to the individual patient, and/or product data, such as dosage data or other information related to the medical product administered to the individual patient may be added to the patient data file for the individual patient. In addition, information identifying the individual provider administering the medical product may also be stored in the patient data file, thereby identifying responsible individuals. Data related to consumption of the medical product may be transferred to a system or individual responsible for inventorying medical products at the provider location. Furthermore, data identifying the individual patient and the medical product administered may be transferred to a system or individual responsible for billing and/or other administrative tasks.

Thus, the system 210 may facilitate updating patient records and ensuring that medical products are administered in a timely manner and are not repeated too frequently.

In addition, the system 210 may allow communication of at least portions of its patient data files 234 via the network 226 to the host computer 224, e.g., to maintain patient-related information in the medical product database 236. For example, the local computer 222 may periodically communicate portions of the patient data files 234 to the host computer 224, or the host computer 224 may periodically query the local computer 222 for updates from the patient data files 234. For example, the host computer 224 may receive demographic data substantially anonymously, e.g., to determine a total number of individuals receiving particular medical products, and/or to determine the number of individuals from traceable demographic groups, e.g., based upon geographic residence, age, race, and the like. The local computer 222 may limit data access by the host computer 224 to protect the privacy of individual patients associated with the patient data files 234.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. A method for administering a medical product to a patient, the method comprising:
providing a delivery device and a medicine data storage device attached to the delivery device;
loading a medical product into the delivery device;
downloading a product identifier into the medicine data storage device, the product identifier identifying the medical product loaded into the delivery device;
uploading the product identifier from the medicine data storage device into a reader at a location in close proximity to an individual patient;
accessing a patient record associated with the individual patient using the reader to confirm that the individual patient is intended to receive the medical product identified by the product identifier; and
administering the medical product to the individual patient once it is confirmed that the individual patient is intended to receive the medical product.

2. The method of claim 1, wherein the patient record comprises a patient data storage device storing a patient identifier associated with the individual patient, and wherein the step of accessing a patient record comprises uploading the patient identifier from the patient data storage device into the reader.

3. The method of claim 2, wherein the patient data storage device comprises at least one of a barcode, a magnetic strip, and an electronic recording device storing the patient identifier thereon.

4. The method of claim 2, wherein the patient data storage device is on a wristband secured to the individual patient.

5. The method of claim 2, wherein the patient data storage device is affixed to a patient chart associated with the individual patient.

6. The method claim 2, further comprising downloading an intended patient identifier into the medicine data storage device, and wherein the step of accessing a patient record comprises comparing the patient identifier with the intended patient identifier to confirm that the individual patient is intended to receive the medical product.

7. The method of claim 6, wherein the intended patient identifier is downloaded when the product identifier is downloaded to the medicine data storage device.

8. The method of claim 1, wherein the uploading and accessing steps are performed in the presence of the individual patient.

9. The method of claim 1, further comprising acquiring product interaction data from a product database related to the medical product identified by the product identifier, and wherein the accessing step further comprises accessing a patient history file to confirm that the medical product is interaction-free from other medical products already received by the individual patient.

10. The method of claim 1, wherein the delivery device comprises at least one of a syringe, a syringe holder, and a unit-dose cartridge.

11. A method for administering a medical product to a patient, the method comprising:
providing a delivery device comprising a medical product therein and a medicine data storage device attached to the delivery device, the medicine data storage device comprising a product identifier identifying the medical product and an intended patient identifier identifying a patient intended to receive the medical product;
uploading the product identifier and the intended patient identifier from the medicine data storage device into a reader;
accessing a patient record associated with the individual patient using the reader to confirm that the individual patient is intended to receive the medical product identified by the product identifier;
comparing the patient identifier with the intended patient identifier to determine whether the individual patient is intended to receive the medical product; and
administering the medical product to the individual patient once it is confirmed that the individual patient is intended to receive the medical product.

12. The method of claim 11, wherein the accessing step comprises uploading a patient identifier from a patient data storage device associated with an individual patient into the reader.

13. The method of claim 12, wherein the patient data storage device comprises at least one of a barcode, a magnetic strip, and an electronic recording device storing the patient identifier thereon.

14. The method of claim 12, wherein the patient data storage device is affixed to a patient chart associated with the individual patient.

15. The method of claim 11, wherein the medicine data storage device further comprises dosage data identifying an amount of the medical product contained within the delivery device, the dosage data being uploaded into the reader when the product identifier is uploaded.

16. The method of claim 15, wherein the patient data storage device comprises desired dosage data identifying an amount of the medical product that the individual patient is to receive, and wherein the method further comprises confirming that the dosage data matches the desired dosage data before administering the medical product to the individual patient.

17. The method of claim 11, wherein the comparing step is performed by the reader, and wherein the reader provides an output indicating whether the intended patient identifier matches the patient identifier.

18. The method of claim 11, wherein the delivery device comprises at least one of a syringe, a syringe holder, and a unit-dose cartridge.

19. The method of claim 11, wherein the uploading and accessing steps are performed where the individual patient is located.

20. The method of claim 11, further comprising acquiring product interaction data from a product database related to the medical product identified by the product identifier, and wherein the accessing step further comprises accessing a patient history file to confirm that the medical product is interaction-free from other medical products already received by the individual patient.

21. A system for administering a medical product to a patient, comprising:
a delivery device comprising a medical product therein and a medicine data storage device attached to the delivery device, the medicine data storage device comprising a product identifier identifying the medical product and an intended patient identifier identifying a patient intended to receive the medical product;
a patient data storage device storing a patient identifier, the patient data storage device being associable with an individual patient, whereby the patient identifier uniquely identifies the individual patient;
an electronic reader configured for uploading the product identifier and the intended patient identifier from the medicine data storage device, the reader configured for uploading the patient identifier from the patient data storage device associated with an individual patient;
a processor coupled to the reader for comparing the patient identifier with the intended patient identifier to determine whether the patient identifier and the intended patient identifier match; and
an output device for indicating whether the patient identifier and the intended patient identifier match, thereby confirming whether the individual patient is intended to receive the medical product.

22. The system of claim 21, wherein the medicine data storage device comprises an electronic recording device comprising memory for storing the product identifier.

23. The system of claim 21, wherein the delivery device comprises at least one of a syringe, a syringe holder, and a unit-dose cartridge.

24. The system of claim 21, wherein the patient data storage device comprises at least one of a barcode, a magnetic strip, and an electronic recording device storing the patient identifier thereon.

25. The system of claim 21, wherein the patient data storage device is affixed to a patient chart associated with the individual patient.

26. A system for acquiring data related to a medical product being administered to a patient, comprising:
a container comprising a medical product therein, the medical product being deliverable from the container to a patient;
an electronic medicine data storage device attached to the container, the medicine data storage device comprising a product identifier stored therein identifying the medical product in the container;
a patient identification device associable with an individual patient, the patient identification device comprising a patient data storage device storing a patient identifier identifying the individual patient;
an electronic reader for acquiring the product identifier from the medicine data storage device and the patient identifier from the patient data storage device;
a communications interface coupled to the reader for acquiring product data associated with the product identifier and patient data associated with the patient identifier; and
memory for storing the product and patient data acquired by the communications interface in a patient data file.

27. The system of claim 26, further comprising a provider computer coupled to the reader within a local network, the provider computer comprising the communications interface and the memory.

28. The system of claim 27, further comprising a host computer at a location remote from the local network, the host computer and provider computer configured for communicating with one another via a communications network.

29. The system of claim 26, wherein the container comprises at least one of a delivery device, an injection device, unit-dose device, and a safety device.

30. The system of claim 26, wherein the medicine data storage device comprises an electronic recording device attached to the container, the electronic recording device comprising memory storing the product identifier.

31. The system of claim 26, wherein the reader comprises a display for displaying at least a portion of the product data.

32. The system of claim 26, further comprising a processor coupled to the memory, the processor configured for acquiring a patient identifier identifying an individual patient, the processor further configured for confirming whether the individual patient is intended to receive the medical product.

33. The system of claim 32, further comprising a patient identification device comprising patient data storage device including the patient identifier, the reader configured for uploading the patient identifier from the patient data storage device.

34. A system for administering a medical product to a patient, comprising:
a delivery device comprising a medical product therein and a medicine data storage device attached to the delivery device, the medicine data storage device comprising a product identifier identifying the medical product and an intended patient identifier identifying a patient intended to receive the medical product;
an electronic reader configured for uploading the product identifier and the intended patient identifier from the medicine data storage device, the reader configured for uploading the patient identifier from the patient data storage device associated with an individual patient;
memory coupled to the reader storing a patient identifier, the patient identifier uniquely identifying the individual patient;
a processor coupled to the reader for comparing the patient identifier with the intended patient identifier to determine whether the patient identifier and the intended patient identifier match; and
an output device for indicating whether the patient identifier and the intended patient identifier match, thereby confirming whether the individual patient is intended to receive the medical product.

35. A method for acquiring data related to a medical product being administered to a patient, comprising:
providing a container at a provider location, the container comprising a medical product therein and a medicine data storage device storing a product identifier identifying the medical product in the container;
uploading the product identifier into a local network at the provider location;
acquiring product data from a product database stored on a host computer at a remote location from the local network, the product data being identified by the product identifier;
administering the medical product to an individual patient;
entering administration date data into a patient data file generally at the time of administration of the medical product to the individual patient, the patient data file being stored on the local network, the patient data file including a patient identifier identifying the individual patient; and
adding the product data to the patient tracking file.

36. The method of claim 35, wherein the container comprises at least one of a syringe, a syringe holder, an injection device, and a unit-dose delivery device.
